(19) United States
(12) Patent Application Publication
(10) Pub. No.: US 2003/0127815 A1
(43) Pub. Date: Jul. 10, 2003

(54) Wheeled vehicles, racks, casters for vehicles, and wheel and frame construction

(76) Inventor: Donald M. Hall, Mount Sinai, NY (US)

Correspondence Address: SHLESINGER, ARKWRIGHT & GARVEY LLP, 3000 South Eads Street, Arlington, VA, 22202, US

(21) Appl. No.: 10/339,417

(22) Filed: Jan. 10, 2003

Related U.S. Application Data
(60) Provisional application No. 60/346,627, filed on Jan. 10, 2002.

(51) Int. Cl. B62B 3/00

(52) U.S. Cl. 280/79.3

(57) ABSTRACT

Mounting assembly has a channel mountable on an object to be moved. A wheel assembly including a mounting plate is detachably attachable to the channel, and a wheel is provided on the mounting plate. A lock is provided for locking the mounting plate with the channel, the lock having a locked condition and an unlocked condition, the locked condition being a condition in which the mounting plate is substantially locked relative to the channel for preventing removal of the mounting plate from the channel. The lock may be a single element, such as a fastener. A signal may be provided for signaling the locked condition and the unlocked condition of the lock. A V-shaped strengthening element may be disposed adjacent the channel for strengthening the channel.

### CROSS REFERENCE TO RELATED APPLICATIONS

This application claims the Convention Priority of Application No. 60/346,627, filed Jan. 10, 2002, which is incorporated herein by reference.

### FIELD OF THE INVENTION

The invention relates to vehicles having wheels. The invention likewise relates to wheeled racks. Further, the invention relates to casters for racks. In addition, the invention relates to wheel and frame constructions for wheeled devices.

### BACKGROUND OF THE INVENTION

Vehicles having wheels or casters are known.

Examples of wheeled vehicles, frame constructions, wheels, and casters, for example, are known from the following patents.

U.S. Pat. No. 338,537 to Westphal et al.

U.S. Pat. No. 263,748 to Miller

U.S. Pat. No. 5,200,240 to Baker

U.S. Pat. No. 2,745,117 to Sands

U.S. Pat. No. 3,685,852 to Wendorf

U.S. Pat. No. 4,422,212 to Sheiman et al.

U.S. Pat. No. 4,589,530 to Sher

U.S. Pat. No. 4,817,237 to Murphy

U.S. Pat. No. 3,935,613 to Kaneko

U.S. Pat. No. 4,698,875 to Kreeger

U.S. Pat. No. 5,428,866 to Aschow

U.S. Pat. No. 5,457,849 to Branson et al.

U.S. Pat. No. 2,790,196 to Rideout et al.

U.S. Pat. No. 3,608,921 to Wilson

U.S. Pat. No. 5,980,008 to Stoever

U.S. Pat. No. 6,162,004 to Hanakawa

U.S. Pat. No. 6,419,098 to Hall

U.S. Pat. No. 6,366,313 to Hall

U.S. Pat. No. 6,322,180 to Hall

U.S. Pat. No. 6,149,120 to Hall

U.S. Pat. No. 6,062,401 to Hall

U.S. Pat. No. 5,628,522 to Hall

U.S. Pat. No. 5,503,087 to Hall

U.S. Pat. No. 4,483,782 to Hall

U.S. Pat. No. 5,471,922 to Hall

U.S. Pat. No. 5,957,309 to Hall

U.S. Pat. No. 5,456,191 to Hall

U.S. Pat. No. 3,386,787 to Hall

U.S. Pat. No. 5,330,064 to Hall

There is a need for improved devices.

### OBJECTS AND SUMMARY OF THE INVENTION

It is an object of the invention to improve upon prior art devices.

It is another object of the invention to provide devices of the type disclosed herein.

It is a further object of the invention to provide racks, casters, wheels, and frame elements which are simpler, easier to manufacture, easier to use, and which make their function more readily apparent to the user than conventional devices.

Another object of the invention is to provide a detachable wheel which may be secured to a wheeled vehicle in its attached position, for example, and which includes a signal indicating its locked and/or unlocked condition.

A still further object of the invention is to provide a structure which is easier to manufacture, yet which may be made stronger than conventional channels.

The invention comprises the various embodiments set forth herein, and the improvements in the fields to which they pertain.

In summary, the invention includes the feature of a wheeled vehicle, at least one wheel of which may be secured to the remainder of the vehicle by a single fastener.

The invention likewise includes a rack having detachably attached wheels attachable to a frame of the rack by a single fastener.

Further, the invention includes a frame element configured for receiving a caster, so that the caster is readily removable for ease of replacement.

In addition, the invention includes an e-channel configured for receiving a portion of a caster, which portion may include a caster plate of a caster.

Still further, the invention includes a double e-channel, one “e” of the e-channel being substantially a mirror image of the other “e” of the double e-channel; and the double e-channel may be configured for receiving a caster plate of a caster.

In addition, a deformation or ramp or other engaging element may be provided in a portion of an e-channel for enhancing the engagement of a portion of a wheel on a wheel vehicle, such as a caster plate of a caster.

The invention further includes a visual reminder to the user, such as whether a wheel or wheels of a wheeled vehicle is in an unlocked or locked position.

Another feature of the invention is the provision of a quick-release lock or mechanism for a wheel.

The invention likewise provides for positive engagement of a body or frame of a vehicle with a wheel, such as a caster.

Another feature of the invention is the provision of a quick-change system for replacement of worn components.

The invention includes a mounting assembly having a channel, and the channel being mountable on an object to be moved. A wheel assembly including a mounting plate is detachably attachable to the channel, and a wheel is provided on the mounting plate. A lock is provided, the lock being configured for locking the mounting plate with the channel, the lock having a locked condition and an unlocked condition, the locked condition being a condition in which the mounting plate is substantially locked relative to the channel for preventing removal of the mounting plate from the channel, and the unlocked condition being a released condition in which the mounting plate is substantially free to move relative to the channel for being detached from the channel. A signal may be operatively associated with the lock, the signal being configuration for signaling the locked condition and the unlocked condition of the lock, the locked condition of the signal signaling the condition in which the lock is in its locked condition, and the unlocked condition of the signal signaling the condition in which the lock is in its unlocked condition; and the locked and unlocked conditions of the signal being visible.

A V-shaped strengthening element may be disposed adjacent the channel for strengthening the channel.

The invention further includes a wheeled vehicle including a rack, the inventive channel, and the inventive mounting assembly.

These are merely examples of the inventive features of the invention set forth herein.

Relative terms such as up, down, left, and right are for convenience only and are not intended to be limiting. The terms caster and wheel may be understood to include wheels, casters, and wheel equivalents.

### BRIEF DESCRIPTION OF THE DRAWINGS

FIG. 1 illustrates an embodiment of a rack having a mounting assembly including a detachable wheel, shown with the detachable wheel secured to the frame of the rack;

FIG. 2 is a perspective view of the embodiment of FIG. 1, showing the detachable wheel released from its engaged position.

FIG. 3 is a cross-sectional view taken along line 3-3 of FIG. 1, showing the wheel locked relative to the remainder of the assembly;

FIG. 4 is a cross-sectional view similar to FIG. 3, showing an unlocked position in which the wheel assembly has been removed;

FIG. 5 is a perspective view of a portion of a further embodiment of the invention showing an assembly in which a detachable wheel is in its locked position;

FIG. 6 is partial cross-sectional view taken along line 6-6 of FIG. 5, showing the locked position;

FIG. 7, is a view similar to FIG. 6, showing an unlocked condition of the lock, after the wheel assembly has been removed;

FIG. 8 is a partial perspective view of a further embodiment of a portion of a mounting assembly on a rack according to the invention, similar to views of FIGS. 1 and 5, showing a detachable wheel assembly in its engaged and locked position;

FIG. 9 is a view similar to FIG. 8, showing the unlocked position and the detached wheel assembly, illustrated in a manner similar to FIG. 2;

FIG. 10 is a partial cross-sectional view of the embodiment of FIG. 8 and 9, showing a locked condition of FIG. 8 in solid line, and a moved unblocked position in phantom line;

FIG. 11 illustrates a further embodiment of the invention and partial perspective view similar to FIG. 9 with a wheel assembly detached from the remainder of the embodiment;

FIG. 12 is a schematic cross-sectional view of another further embodiment of an e-channel according to the invention, and a locking assembly;

FIG. 13 is a cross-sectional view of another embodiment of a channel according to the invention, specifically, a double-e-channel;

FIG. 14 illustrates a perspective view of a larger portion of a wheeled vehicle such as a rack according to the invention

FIG. 15 illustrates a perspective view of a portion of a further assembly according to the invention, including a lockable, detachable wheel assembly and another embodiment of a channel according to the invention;

FIG. 16 is a sectional view of the channel of the embodiment of FIG. 15;

FIG. 17 is a perspective view on an enlarged scale of a portion of the embodiment of FIG. 15;

FIG. 18 is a perspective view of a further embodiment of the invention shown in a manner similar to FIG. 17;

FIG. 19 is a partially broken away partial perspective view of another embodiment of the invention, showing a lockable, detachable wheel assembly in its locked condition;

FIG. 20 illustrates the embodiment of FIG. 19 in its unlocked condition with a wheel detached from the remainder of the assembly;

FIG. 21 is a perspective view of a portion of a locking device of the embodiment of FIGS. 19 and 20;

FIGS. 22-26 illustrate partial perspective views of further respective embodiments of the invention;

FIG. 27 is a partial perspective view of another embodiment of the invention;

FIG. 28 illustrates a portion of FIG. 27 on an enlarged scale;

FIG. 29 illustrates the embodiment of FIG. 27, partially exploded; and

FIG. 30 shows a portion of FIG. 29 on an enlarged scale.

### DETAILED DESCRIPTION OF THE INVENTION

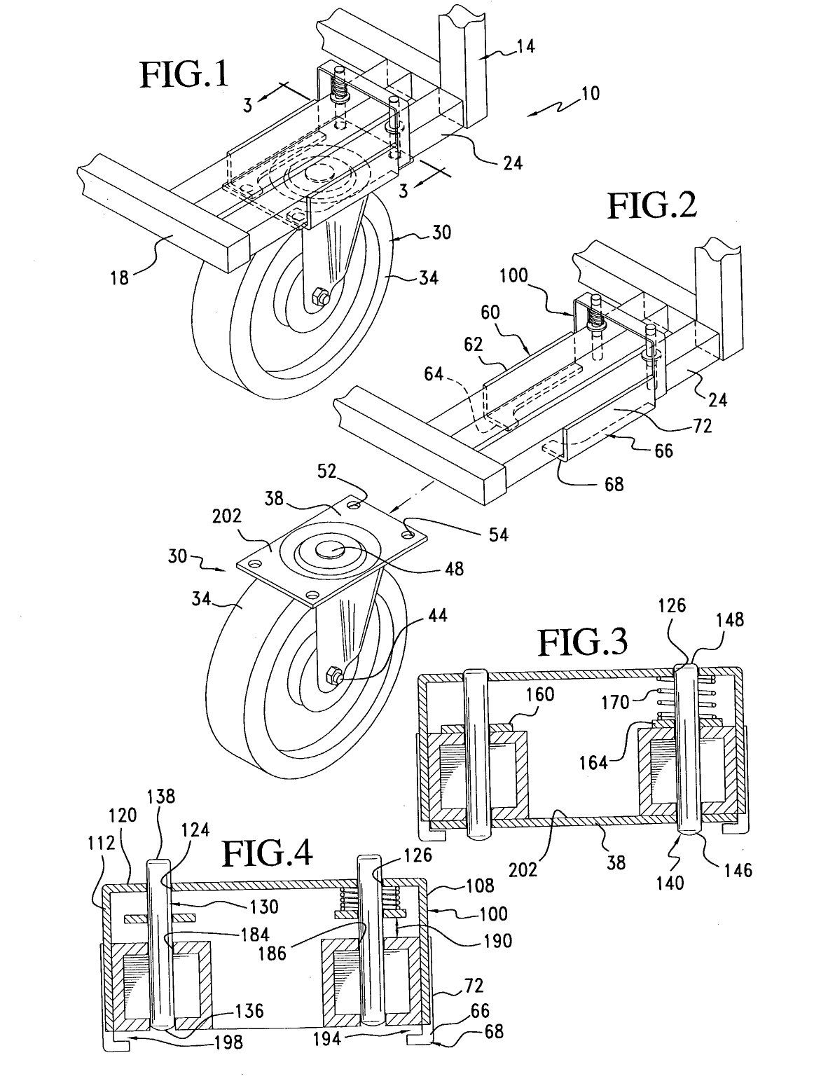

FIGS. 1-4 illustrate an embodiment of a wheeled vehicle 10, such as a rack, according to the invention.

Rack 10 may include a frame 14 including one or more frame elements 18 and 24. Frame element 24 may be termed a channel or channel element for ease of discussion.

A wheel assembly 30 may include a movably attached wheel 34 movably attached to a mounting portion 38, such as a caster or mounting plate, by means of an axle 44 around which wheel 34 may rotate.

A support element 60 including an upper leg 62 and a lower leg 64 may be provided on frame member 24 and a counterpart support 66 including a lower leg 68 and an upper leg 72 may be provided on frame member 24.

Support members 60 and 66 may be bolted or welded to frame member 24, for example.

Mounting plate 38 may be rotatable about an upwardly extending axis 48, in a conventional fashion, as desired.

One or more apertures or holes 52 and 54 may be provided in mounting plate 38, for use in securing wheel 30 to the remainder of rack 10.

A lock 100 may be provided for securing wheel 30 to the remainder of rack 10 when lock 100 is in its locked position, as shown in FIGS. 1 and 3.

Lock 100 may include a frame or housing having side portions 108 and 112, and an upper portion 120 connecting the two. One or more holes 124 and 126 may be provided through upper portion 120. Holes 124 and 126 may be sized for receiving a lock element or lock or pin 130 therein or therethrough.

Pin 130 may include a lower end 136 and an upper end 138.

A further pin 140 having a lower end 146 and an upper end 148 extending into or through hole 126, as illustrated, may likewise be provided.

Pin 130 may include a spacer or stop element 160 which is configured or positioned for determining the extent of movement of pin 130 functioning as a locking element, for example.

A further stop or positioning or guide element 164 may be provided on pin 140, stop 164 having an added function, such as serving as a platform on which a spring 170 rests, which spring 170 is thereby captured between stop 164 and upper member or element 120.

Both stops 160 and 164 may be configured for being grasped by an operator for actuating the respective lock element 130 and 140.

It will be appreciated that an operator may grasp and readily move lock element 130 upwardly, as will be readily understood by considering the upwardly moved position of FIG. 4 in which the lock 130 has been moved sufficiently upwardly so as to be in its unlocked position. The upward movement may be accomplished by use of the operator's fingers pushing upwardly on a portion of lock element 130, specifically on the body of lock element 130 or by grasping stop 160 and moving it upwardly.

In the case of lock element 140, the operator would likewise move lock element 140 upwardly as shown when considering the moved position of FIG. 4 in which lock element 140 is in its unlocked position, as compared with the locked position of FIG. 3. When the operator moves lock 140 into its unlocked position, the operator must overcome the force exerted by spring element 170. Spring element 170 may be installed in a pre-tensioned state, by partial compressing spring element 170 sufficiently prior to installation between stop 164 and upper member 120 so that a spring force is being exerted against upper 120 and top 164 so as to constantly maintain lock element 140 in its locked condition of FIG. 3.

One or more holes 184 and 186 may be provided in respective portions of frame element 24 through which lock elements 130 and 140 respectively, pass.

In use, it will likewise be apparent that lock element 140, for example, must move away from engagement with mounting plate 38 at least a distance 190, as shown in FIG. 4, so that mounting plate 38, and hence, wheel assembly 30 may be detached for the remainder of rack 10. Distance 190 is shown as being substantially equal to movement sufficient so that lower end 146 of lock element 140 is sufficiently above a top surface 202 of mounting plate 38 so that mounting plate 38 may be slid along respective spaces or slots 194 and 198 sized to fit mounting plate 38.

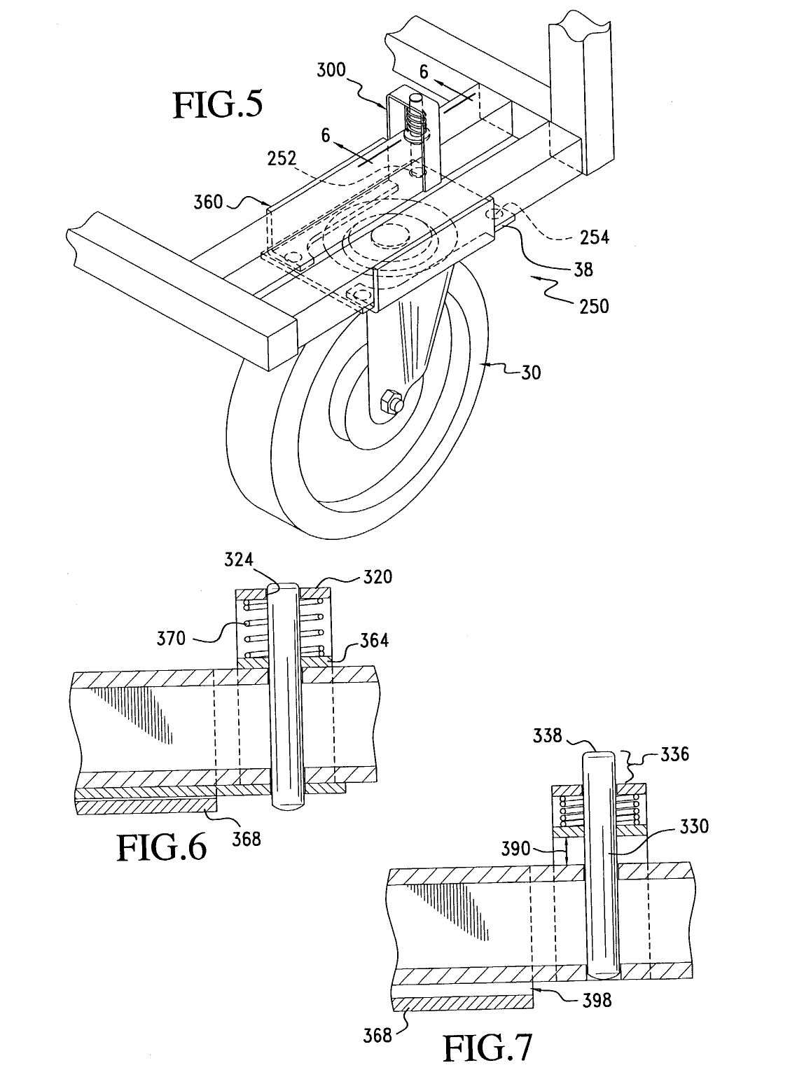

FIGS. 5-7 illustrate another embodiment of a wheeled vehicle or rack to 250 according to the invention.

Rack 250 may include wheel assembly 30, such as described above. Wheel assembly 30 may include one or more hole 252 and 254. At a minimum, hole 252 is contemplated for use in conjunction with lock 300.

Lock 300 may include a frame or housing 320 including a hole or aperture 324 provided in an upper portion thereof. A locking element 330 may extend a distance 336 outwardly of housing 320 when an upper end 338 of locking element 330 is moved sufficiently out of its locked position into its unlocked position for disengaging from mounting plate 38; i.e., moving sufficiently out of hole 252 so that mounting plate 38 and the remainder of wheel assembly 30 may be disengaged from rack 250. A support 360 may be provided having a lower leg 368 defining a channel 398 sized for receiving mounting plate 48.

A stop 364 which captures a spring 370 between itself and housing 320 may be provided in a manner analogous to spring 170 of the embodiment of FIGS. 1-4.

The channel defined between lower leg 368 and the frame of rack 250 has been indicated at 398.

It will be appreciated that the end 338 extending outwardly of housing 320 may serve as a visual indicator that pin 330 is in its unlocked condition. The distance or portion indicated by reference numeral 336 may be provided with a contrasting color or contrasting configuration, such as by painting, for example, so as to more readily indicate that lock 300 is in its unlocked position. Thus, is use, when a wheel assembly 30 is being inserted into channel 398, if the mounting plate 38 is not positioned in its fully mounted position with hole 252 aligned with locking pin 330, then locking pin 330 will remain in its extended position with free end 338 extending outwardly of housing 330, thereby exposing portion 336. Portion 336 thus serves as a visual indicator that mounting plate 338 has not been placed in its completely engaged position.

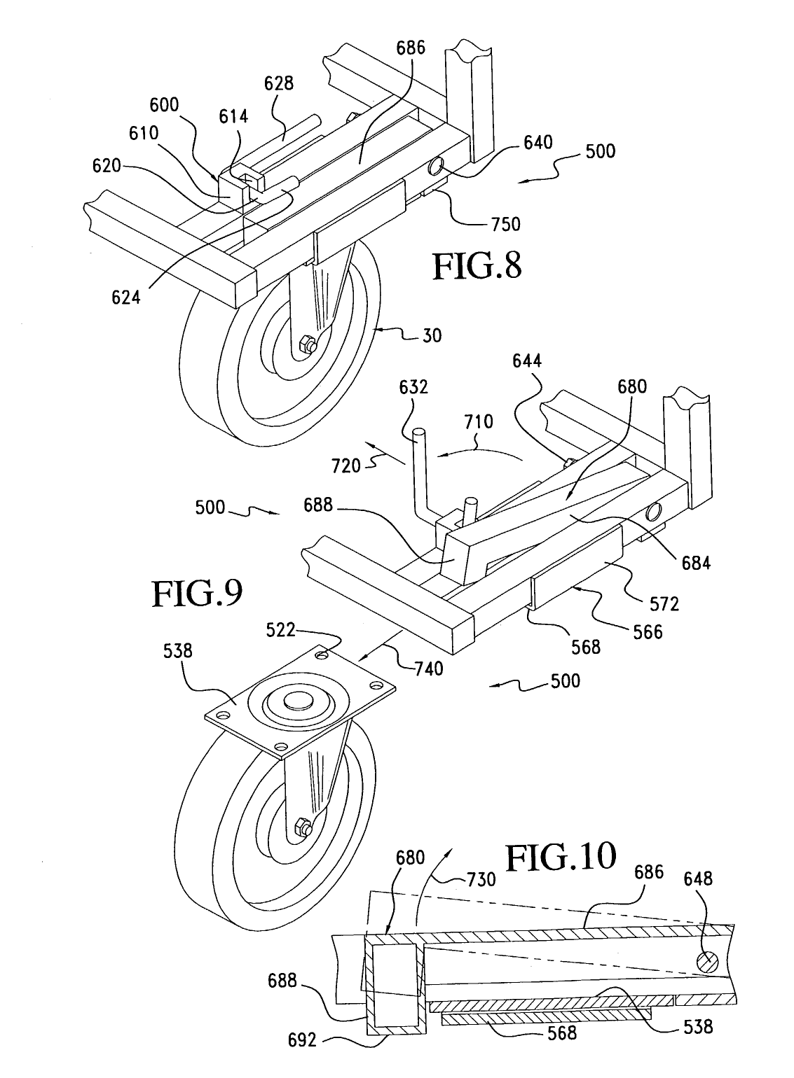

FIGS. 8-10 illustrate another embodiment of a wheeled vehicle or rack 500 according to the invention.

Rack 500 may include a frame analogous to the frame of the FIG. 5 embodiment and wheel assembly 30 including a mounting plate 538. In this FIG. 8 embodiment illustrated holes 522 in mounting plate 538 are optional, as will be appreciated from the following description, in which there need be no components, such as locking elements or pins which engage holes 522.

In a manner analogous to the embodiment of FIG. 1, a mounting channel in which mounting plate 538 is received may be provided by use of an e-channel, such as by use of an L-shaped element 566 mounted on the frame that has a lower leg 568 and an upper leg 572.

A lock or locking device 600 may be provided for ensuring that wheel assembly 30 is fixedly attached to the remainder of rack 500 when mounting plate 538 is in its fully mounted position, and lock 600 is in its locked position.

Lock 600 may include a housing or guide 610 having a guide element 614, such as the illustrated slot provided therein. Guide 614 may be sized and configured for rotatably and slidably receiving a lock or a locking element 620 therein. Lock element 620 may include a first portion 624 such as the illustrated arm 624. Further, an actuator or lever arm 628 may be provided for changing locking device 600 from its locked to its unlocked position.

An axis may be provided by use of a bolt 640 which may be secured to the frame by a nut 644. Bolt 640 may be provided with a shaft 648 sufficiently long for use as an axis or pivot, for example, about which an engaging or blocking element or block 680 pivots. Block 680 restricts removal of mounting plate 538 when block 680 is in its lowered, blocking position, as shown in FIGS. 8 and 10. This may be accomplished by use of a downwardly extending portion 688 extending away from a top surface 686 of a first portion 684 that may be in the form of an elongated leg, as shown.

It will be appreciated that, in use, in order to change blocking device 600 from its locked position of FIG. 8, and the solid line locked position of FIG. 10, actuator arm 632 may be first moved in direction 710, such as pivoting, and then moved in a direction 720 for concurrently moving arm 624 away from engagement with block 680; i.e., from engagement with top surface 686 of block 680. The configuration of housing 610 and slot 614 may be such so that actuator 632 and leg 624 remain in an upright position after having been moved in direction 720. That upright position of actuator 632 both keeps leg 624 free from engagement with block 680, and also functions as a signal to the user that lock 600 is in its disengaged and unlocked position in which block 680 may be moved in a direction 730, such as pivoting about shaft 648 as shown in FIG. 10. The user thus may readily know that wheel assembly 30 may be removed and that lock 600 is in its unlocked disengaged position. The size, length, and/or configuration of leg 620 may be selected so that even when actuator 632 has been moved in direction 710 but not yet moved in direction 720, a portion of one or both of leg 620 and 624 may continue to engage top surface 686 of block 690 for preventing disengagement of block 680 until the user has taken a second, positive step of moving actuator 632 and hence legs 620 and 624 out of engagement with block 680.

It will be readily appreciated that movement of block 680 in direction 730 must be sufficient so that a lower portion 692 of downwardly extending portion 688 is disposed sufficiently above an upper surface of mounting plate 538 so that mounting plate 538 may be moved past lower portion 692 in a direction 740 out of its engaged position.

A further stop 750 may be provided on the frame that may serve as a guide for the user when inserting the wheel assembly 30 so that the user knows when mounting plate 538 abuts against stop 750, and the mounting plate is in its desired position for being locked in place by block 680 and locking device 600. Block 750 may be sized and configured for enhancing the structure in the vicinity of bolt or pivot 640.

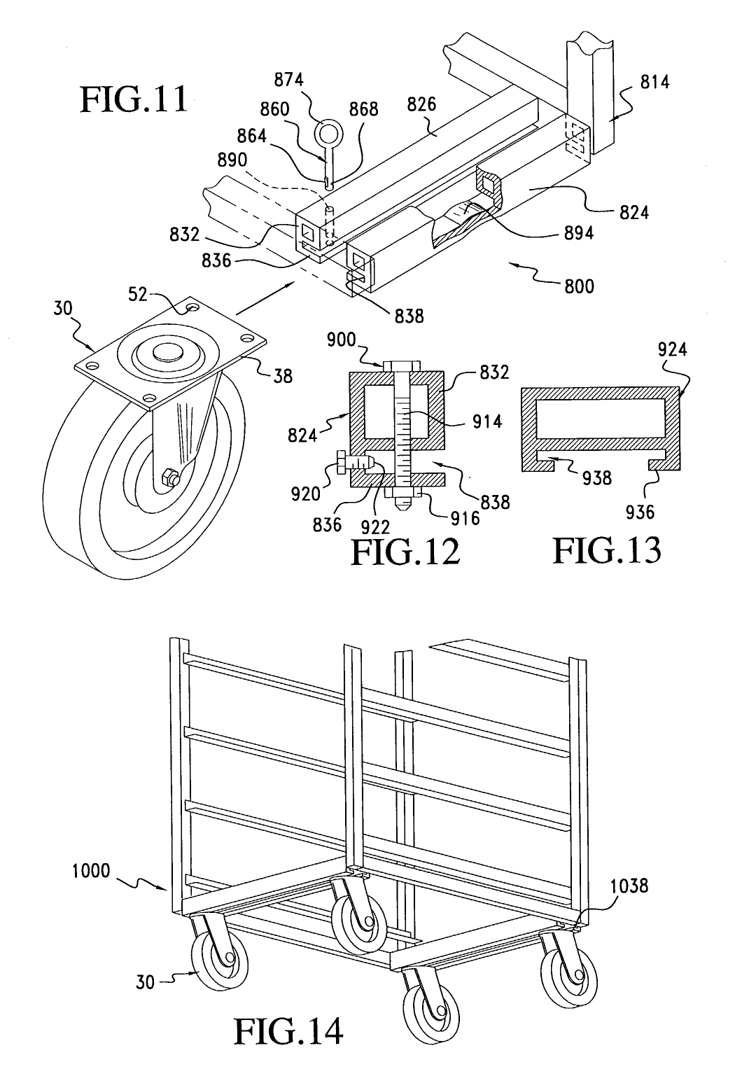

FIG. 11 and 12 illustrate another embodiment of a wheeled vehicle or rack 800 according to the invention.

Rack 800 may include a detachable wheel assembly 30 having one or more holes 52 and 54 provided in mounting plate 38.

A frame 814 may be provided with first and second frame numbers 824 and 826, respectively. Frame numbers 824 and 826 may be so-called e-channels having an upper portion 832 and a lower portion 838 and 836, respectively, which define respective guides or slots 838 which receive mounting plate 38.

A locking device or element 860 may be provided for securing wheel assembly 30 to the remainder of rack 800. Locking device 860 may include an engaging element 864 on a pin or shaft 868. A grasping element such as a pull ring 874 may be provided for assisting the user in inserting and removing locking element or pin 868 into and from an aperture or hole 890 provided in e-channel 826.

Engaging element 864 may be resilient or spring-loaded for normally extending outwardly of pin 868, except when a force is applied pushing element 864 inwardly of pin 868, for example. In that manner, when locking element 860 is inserted for engaging frame number 826 and hole 856 of mounting plate 38, respective portions of sides of hole 890 in frame member 826 and hole 52 may press against resilient element 864 and press engaging element 854 sufficiently inwardly into the body of pin 868 so that locking element 860 may be inserted into holes 890 and 52. After locking element 860 has been moved sufficiently downwardly as shown in FIG. 11 so that engaging element 864 has passed and is disposed outwardly of, namely below frame number 826 as shown in FIG. 11, then no inward forces are pressing against engaging element 864 and it is able to resume its normally outwardly extending position. In that manner, if an operator attempts to disengage locking device 860 by pulling upwardly on handle 874, locking device 860 could not be removed. That is because an inward force against engaging element 864 such as by an operator pressing engaging element 864 radially inwardly into the body of pin 868 must first be applied so that the top portion of engaging element 864 will not abut against a lower face of frame number 826 and, prevent upward movement of locking device 860.

A retaining element 894 may be provided for serving as a stop to alert the user that mounting plate is in its fully inserted position ready for being locked to the remainder of rack 800, or protrusion 894 may be configured for reducing the extent (e.g. height) of slot 838 for engaging mounting plate 38 and thus assisting in the retention of mounting plate 38 or both. Element 894 may be configured for ramping plate 38 upwardly into engagement with the walls of slot 838 when plate 38 is inserted.

FIG. 12 illustrates another embodiment of the invention similar to the embodiment of FIG. 11, with the provision of a bolt 900 having a shaft 914 and a fastener 916, such as the illustrated nut. Bolt 900 may be used instead of or in addition to locking device 860 of FIG. 11.

A set screw 920 may be provided extending into slot 838, instead of or in addition to bolt 900. As will be appreciated, set screw 920 may be screwed sufficiently inwardly so that a free end 922 engages a portion of mounting plate 38 when mounting plate 38 is received in slot 838. When mounting plate 38 is to be removed along with real assembly 30, set screw 920 may be loosened sufficiently for disengaging free end 922 from mounting plate 38.

FIG. 13 illustrates another embodiment of a frame member according to the invention, including what may be termed a double-e-channel 924. Double-e-channel 924 may be provided with one or more lower legs 936 configured and extending for defining respective slot or slots 938 in which mounting plate 38 of wheel assembly 30 may be received.

FIG. 14 illustrates a wheeled vehicle 1000, such a rack according to the invention. Wheel assemblies 30 are shown mounted in respective slots 1038.

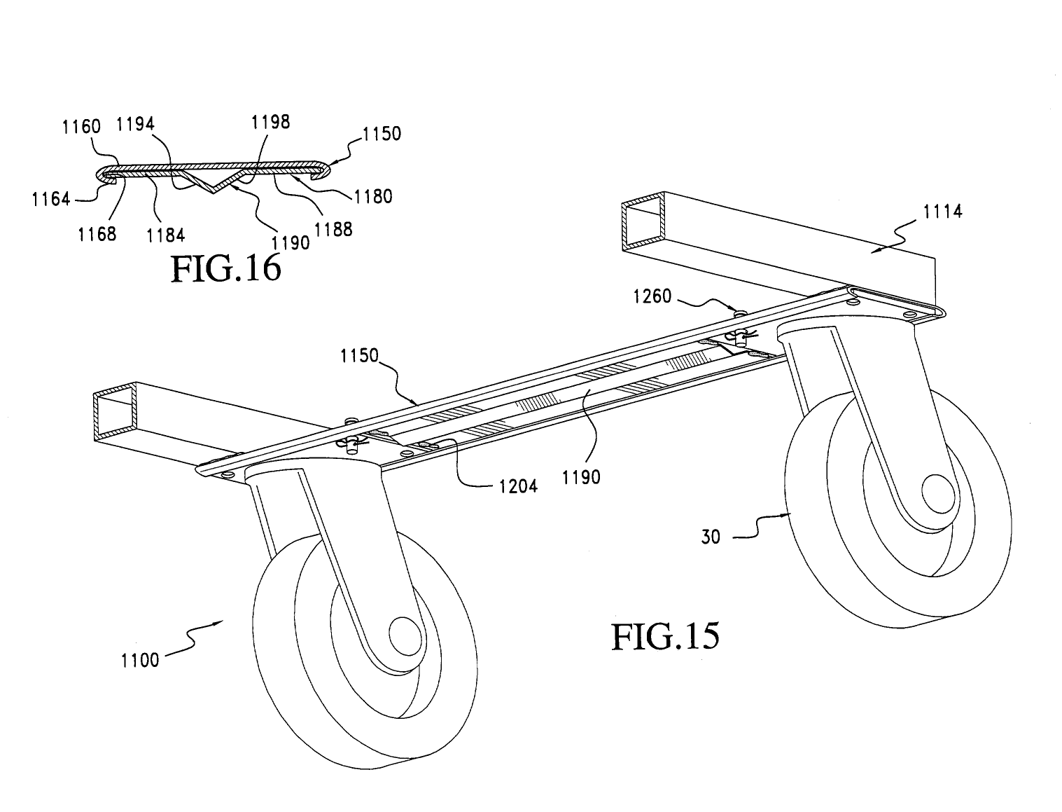

FIGS. 15-17 illustrate another embodiment of a rack 1100 according to the invention.

Rack 1100 may include a frame 1114 having a first or upper channel 1150. Upper channel 1150 may include an elongated central portion 1160 and one or more curved or bent portions 1164 defining respective slots 1168. A lower or second or V-shaped channel 1180 may be provided adjacent upper channel 1150. Lower channel 1180 may include a left arm 1184 and a right arm 1188. A v-shaped element 1190 having a left side 1194 and a right side 1198 defining the substantially v-shaped portion may be provided. It is contemplated that at least one of left arm 1184 and right arm 1188 be configured for being received in guide 1168. Depending on the intended use and method of manufacture, guide 1168 may be first formed, and then arm 1184 may be slid or inserted therein. Alternatively, V-shaped channel 1180 may be provided adjacent upper channel 1150, and the bent portion 1164 may be bent around and engage a free end of left arm 1184 for securely engaging it.

One or more welds 1204 and 1206 may be used to enhance the connection between V-shaped channel 1180 and upper channel 1150.

Thanks to the provision of V-shaped channel 1180 adjacent upper channel 1150, a stronger channel element is achieved than a conventional channel, yet with reduced weight and cost.

In the case where the channel is used on rack 1100, detachable wheel assembly 30 may be provided. In use, mounting plate 38 may be slid into guides 1168 defined in upper channel 1150 as described above, and which guides 1168 are unoccupied portions of V-shaped channel 1180.

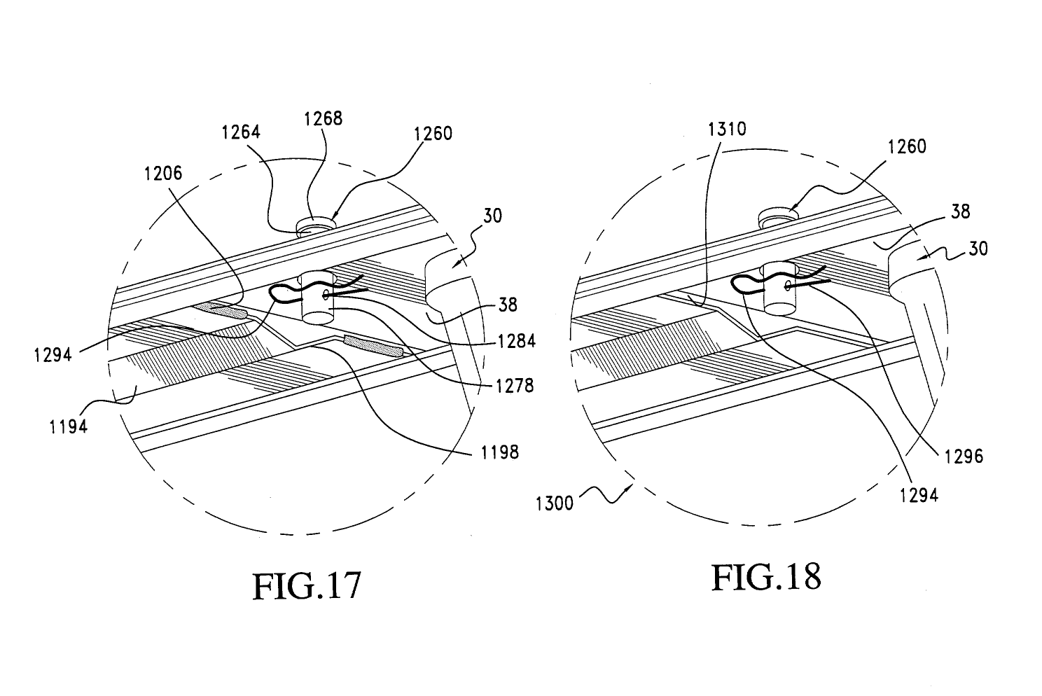

A locking device 1260 may be provided, such as the illustrated locking pin 1264 having an enlarged upper end 1268 and a shaft 1278 extending through sufficiently long portions of upper channel 1150 and a sufficient portion of mounting plate 38 so that mounting plate 38 is substantially unable to be disengaged from the remainder of rack 1100 when locking device 60 is locked. In order to remove wheel assembly 30 from channel 1150, a securing element such as a cotter key or cotter pin 1294 is moved leftwardly as viewed in FIGS. 15 and 17, so as to remove a leg 1296 of cotter key or cotter pin 1294 from hole or aperture 1284. The remainder of locking device 1260 is then moved upwardly as shown in FIGS. 15 and 17, sufficiently upwardly so that shaft 1264 no longer engages mounting plate 38 and prevents removal thereof by moving mounting plate 38 rightwardly as viewed in FIGS. 15 and 17, for example. In describing the use of locking device 1260, FIG. 17 has been described as being an enlarged view of the right hand one of wheel assemblies 30 of FIG. 15.

FIG. 18 illustrates another embodiment of a rack 1300 to according the invention, similar to the embodiment of FIGS. 15-17, with the feature that no weld is provided in a region 1310; namely, no weld is provided for “permanently” securing or integrally attaching V-shaped channel 1180 to upper channel 1150. In that manner, manufacture of rack 1300 is simplified. To assemble the frame element, one need simply to slide the V-shaped channel 1180 is simply slid into slot 1168. Then left hand and right hand wheel assemblies 30 can be placed on the outer ends thereby capturing V-shaped channel in place, the locking devices 1260 detachably attaching and sufficiently rigidly securing two (2) wheel assemblies 30, upper channel 1150, lower channel 1180, and the locking device together.

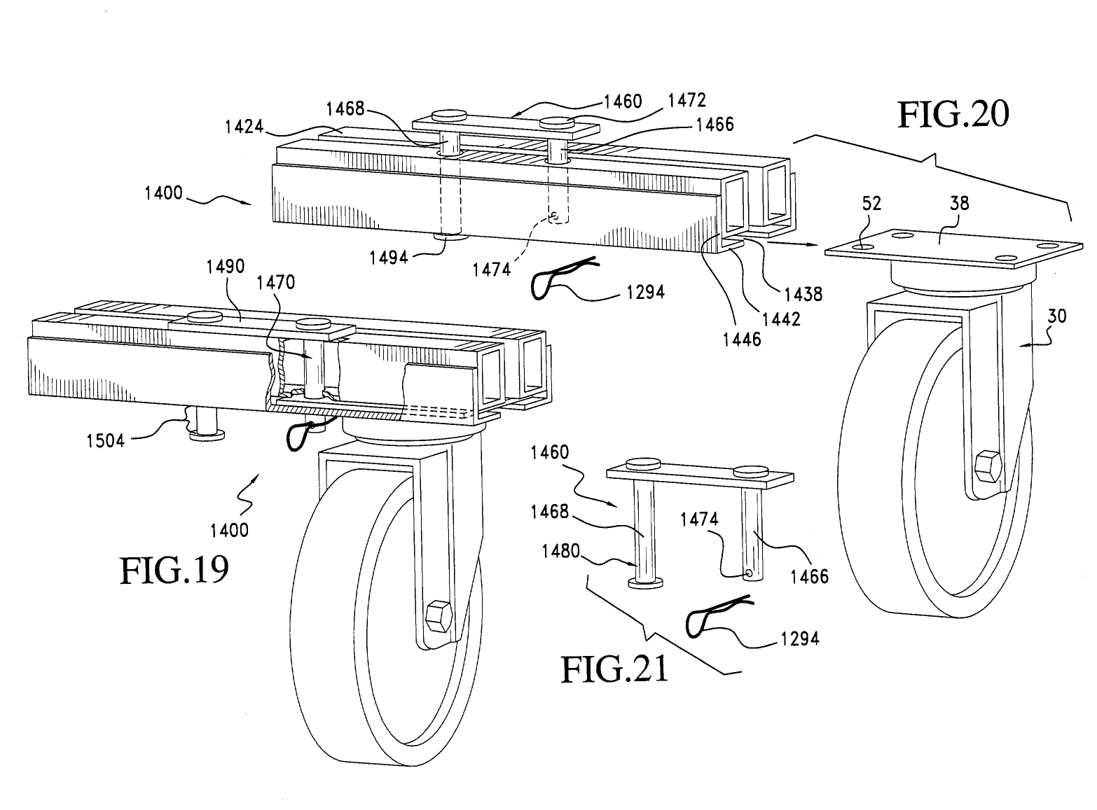

FIGS. 19-21 illustrate another embodiment of a wheeled vehicle 1400 such as a rack, according to the invention.

Vehicle 1400 may include frame number 1424, such as the illustrated e-channels, one or both of which may include a respective slot 1438 defined by one or both of a lower leg 1442 and an upper leg 1446. Leg 1446, for example, may be welded, bolted or attached to the remainder of channel 1424, or formed as an integral extrusion.

The mounting plate 38 of wheel assembly 30 may be received in slot 1438, and hole 52 will assist in securing wheel assembly 30 to pin or locking element 1466 of locking device 1460. An upper portion 1472 may be provided on pin or locking element 1466, and a recess or aperture 1474 may be provided which is sized for receiving cotter key or cotter pin 1294.

A further pin 1468 having one or more enlarged portions 1494 may likewise be provided. Pin 1468 and enlarged portion 1494 function to capture locking device 1460 relative to frame 1424, for example, so that locking device 1460 may not be lost, in use. When pin 1470 extends through hole 52, cotter key or cotter pin 1294 secures it in place and locks mounting plate 38 relative to frame 1424. In its locked condition, further pin 1468 may extend a distance 1504 outwardly, downwardly as viewed in FIG. 19, of frame 1424. Height 1504 may be sufficiently long so that when wheel assembly 30 is to be released, cotter key or cotter pin 1294 is removed from aperture 1474, and locking device 1460 is moved upwardly. Distance 1504 allows shaft 1466 to be disposed above an uppermost portion of mounting plate 38 when enlarged portion 1494 abuts a lower face of leg 1442. Quite simply, pin 1470 will be sufficiently withdrawn from engagement with hole 52 so that mounting plate 38 may be disengaged and move rightwardly as viewed in FIG. 20. The provision of and configuration of pin 1468 joined to pin 1470 ensure that even when cotter key or cotter pin 1294 has been removed, the user must still positively move locking device 1460 upwardly by the distance 1504 so as to overcome a tendency of the locking device to remain in place, thereby reducing the likelihood that wheel assembly 30 will be unintentionally disengaged from rack 1400.

The channel need not extend the entire length of frame member 1444, the channel may be relatively short. Pin 1468 or enlarged portion 1494 or both may be configured or sized to block leftward movement of wheel assembly 30, as viewed in FIG. 20, to prevent disengagement of wheel assembly 30 from rack 1400 in the event both cotter pin 1294 is disengaged and lock 1460 is in its disengaged position, such as pin 1466 having been moved upwardly sufficiently to allow leftward movement of mounting plate 38 past pin 1466, pin 1468 and enlarged portion 1494 likewise being in their upwardly moved position. The size and configuration of pin 1468 and portion 1494 may be sized so as to prevent leftward movement of plate 38 even when pin 1468 and enlarged portion 1494 are in their most upwardly moved position.

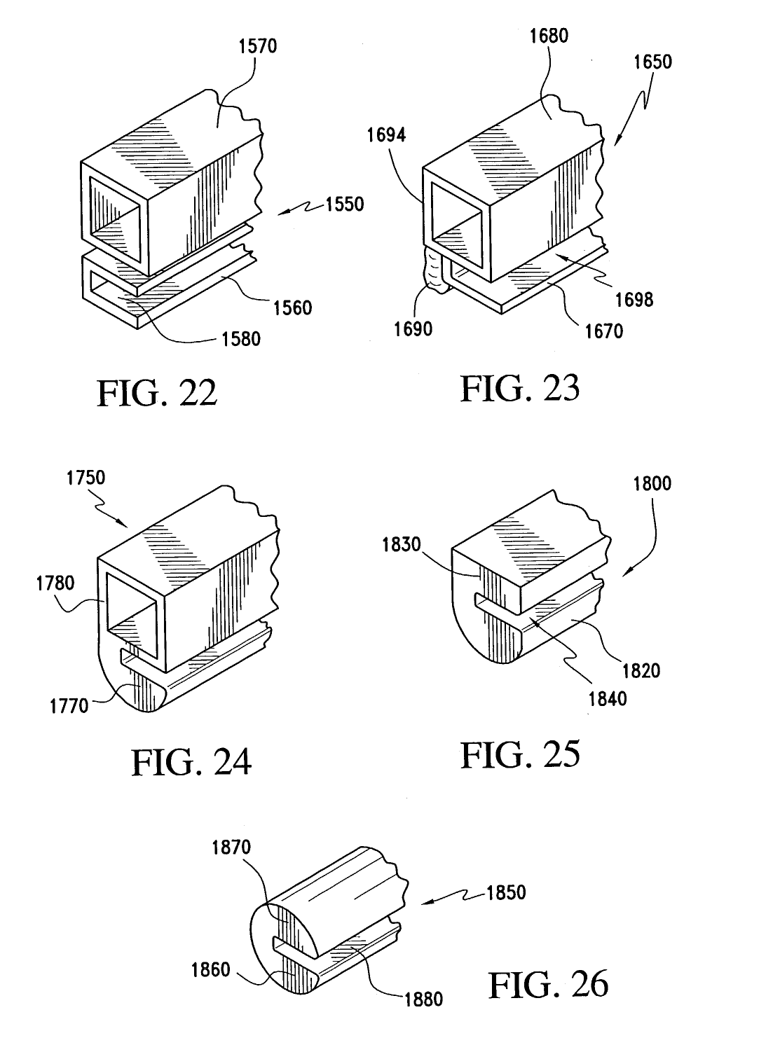

FIG. 22 illustrates another embodiment of a frame element 1550 according to the invention. Frame element or member 1550 may include a lower C-channel fixedly attached to an upper square or box-channel 1570. The FIG. 22 illustration is an exploded view prior to fixedly attaching C-channel 1560 to channel 1570. When attached, such as by welding together, an e-channel results, including a guide or slot 1580 which may be sized for receiving mounting plate 38 of wheel assembly 30, as described above.

FIG. 23 illustrates another embodiment of a frame member 1650 including a lower portion 1670 and an upper portion 1680 according to the invention. In use, a weld 1690 may secure L-shaped channel 1670 at a location disposed inwardly of an outer edge 1694 of channel 1680. A guide or slot 1698 may be provided.

FIG. 24 shows another embodiment of an e-shaped channel according to the invention having a lower portion 1770 and an upper portion 1780. Channel 1750 may be formed as a continuous extrusion.

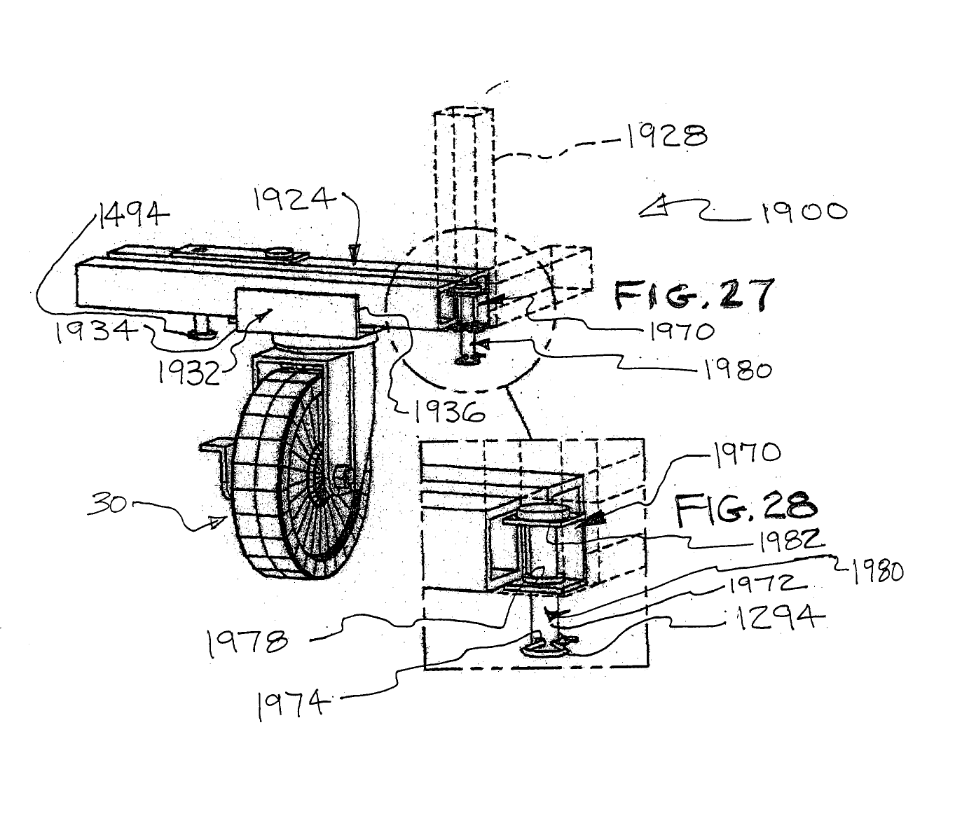

FIG. 25 illustrates another embodiment of a frame member 1800 according to the invention having a lower arm 1820 and an upper arm 1830 defining a guide or slot 1840 therebetween, in which mounting plate 38 of wheel assembly 30 may be received. Frame member 1800 may be formed as a C-shaped extrusion.

FIG. 26 illustrates another C-shaped channel member 1850 according to invention that may include a lower leg 1860 offset from an upper leg 1870 defining a slot 1880 therebetween sized for receiving mounting plate 38.

FIGS. 27-30 illustrate another embodiment of a wheeled device or rack 1900 according to the invention, similar to the embodiment of FIGS. 19-21, for example.

FIGS. 27 and 28 illustrate an engaged and locked position in which wheel assembly 30 is mounted on a channel 1932. Channel 1932 may include a lower leg 1934 and an upper leg 1936 defining a channel configured for receiving mounting plate 38 of wheel assembly 30, along the lines described above.

A frame member 1924 may include an upright or upwardly extending frame element 1928 attached thereto.

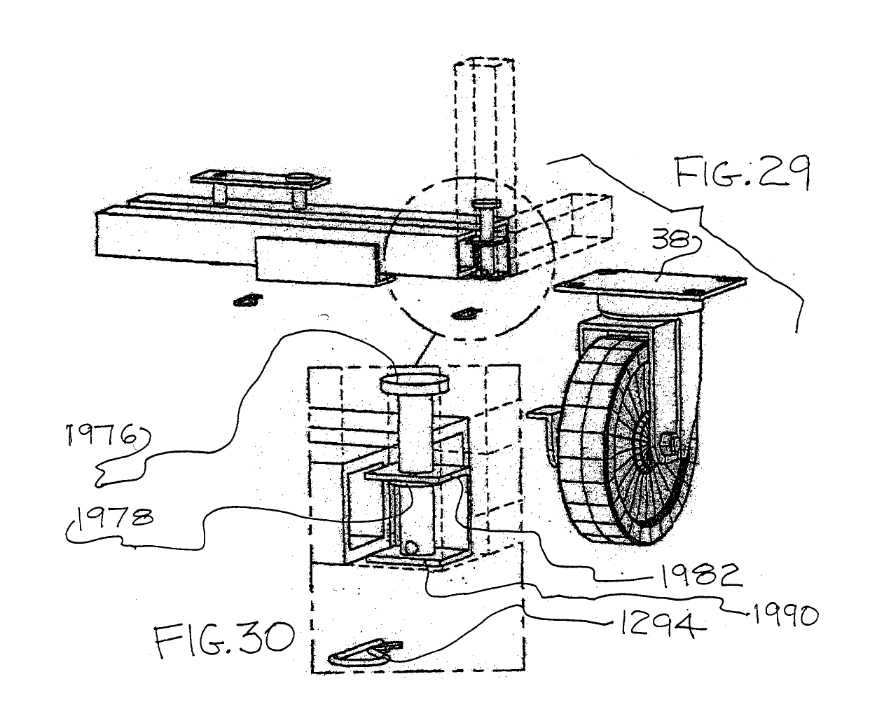

A further block such as the illustrated mechanical block 1970 may be provided for blocking removal of wheel assembly 30 from the remainder of rack 1900 when further block 1970 is in its normal, blocking position, as shown in FIGS. 27 and 28. The normally blocking position may be gravity-actuated so that when rack 1900 is in a substantially upright position, a blocking element 1980 would normally move downwardly into its illustrated downwardly moved blocking position. Blocking element 1970 may include a mechanical block 1972, such as the illustrated pin, a hole or aperture 1974 defined therein, and an upper enlarged portion 1976. Upper enlarged portion 1976 may be configured for determining the extent of downward movement of pin 1972 from its upper or raised position of FIGS. 29 and 30 to its lowered position of FIGS. 27 and 28.

A lower enlarged portion 1978 may be provided. Lower portion 1978 may be sized and configured for determining the extent of upward movement of pin 1972 from its lower position of FIGS. 27 and 28 to its upper position of FIGS. 29 and 30, thanks to its contacting a lower face of support 1982. Needless to say, upper enlarged portion 1976 may be situated and configured for engaging an upper face or portion of support 1982 for preventing further downward movement of pin 1972, and hence, blocking element 1970.

A lower support or guide element 1990 may be provided, as shown.

As in the embodiment of FIGS. 19-21, head or enlarged portion 1494 may be sized and configured for preventing leftward movement of wheel assembly 30, except when desired by the operator depending on the intended use. Pin 1468 and enlarged portion 1494 may be sized so that wheel assembly 30 is never able to pass one or both of pin 1468 and 1494, regardless of the extent of upward movement of pin 1468, and hence, enlarged portion 1494.

It will be appreciated that all the components may be made of various synthetic materials including plastics, thermoplastics, carbon-reinforced materials, fiberglass reinforced plastic (frp), metal plates and channels bolted and welded together and the like, and extrusions of aluminum, steel and other materials.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. A mounting assembly, comprising:
a) a channel, the channel being mountable on an object to be moved;
a) a wheel assembly, the wheel assembly including:
i) a mounting plate, the mounting plate being detachably attachable to the channel;
ii) a wheel provided on the mounting plate, the wheel being movable relative to the mounting plate;
c) a lock being provided, the lock being configured for locking the mounting plate with the channel, the lock having a locked condition and an unlocked condition, the locked condition being a condition in which the mounting plate is substantially locked relative to the channel for preventing removal of the mounting plate from the channel, and the unlocked condition being a released condition in which the mounting plate is substantially free to move relative to the channel for being detached from the channel;
d) a signal being operatively associated with the lock, the signal being configuration for signaling the locked condition and the unlocked condition of the lock, the locked condition of the signal signaling the condition in which the lock is in its locked condition, and the unlocked condition of the signal signaling the condition in which the lock is in its unlocked condition; and
e) the locked and unlocked conditions of the signal being visible.

2. A mounting assembly as in claim 1, wherein:
a) the signal is a mechanical signal; and
b) the mechanical signal extends outwardly of the channel.

3. A mounting assembly as in claim 1, wherein:
a) the lock includes a hand-actuatable handle which extends outwardly of the channel.

4. A mounting assembly as in claim 1, wherein:
a) the lock is movably attached to the channel; and
b) the lock can be moved to its locked position when the mounting plate is attached to the channel.

5. A mounting assembly as in claim 4, wherein:
a) the lock is movably attached to the mounting bracket; and
a) the lock can be moved to its unlocked position when the mounting plate is attached to the channel.

6. A mounting assembly as in claim 1, wherein:
a) the signal includes a handle for moving the lock between its locked and unlocked conditions.

7. A mounting assembly as in claim 1, wherein:
a) the signal can only be returned to its locked position when the mounting plate is attached to the channel.

8. A mounting assembly as in claim 7, wherein:
a) a mechanical block is provided; and
b) the mechanical block is disposed for preventing the lock from being returned to its locked condition when the mounting plate is less than substantially engaged with the channel.

9. A mounting assembly as in claim 8, wherein:
a) the mechanical block includes a pin.

10. A mounting assembly as in claim 8, wherein:
a) a spring is provided for biasing the mechanical block into the locked position.

11. A mounting assembly as in claim 7, wherein:
a) the signal includes a pin.

12. A mounting assembly as in claim 1, wherein:
a) the signal is integral with the lock.

13. A mounting assembly as in claim 1, wherein:
a) the lock includes a first lock and a second lock;
b) the first lock is detachably attached to one of the channel and the mounting plate; and
c) the second lock is movable relative to and captured by one of the channel and the mounting plate.

14. A mounting assembly as in claim 13, wherein:
a) The first lock is fixed in its locked condition by a detachable securing element.

15. A mounting assembly as in claim 10, wherein:
a) The signal includes a further signal.

16. A mounting assembly as in claim 9, wherein:
a) the mechanical block is pivotably attached to the channel.

17. A mounting assembly as in claim 2, wherein:
a) A portion of the signal contrasts with the remainder of the signal for providing a further visual signal.

18. A mounting assembly as in claim 1, wherein:
a) The channel includes a C-channel.

19. A mounting assembly as in claim 18, wherein:
a) The C-channel includes a tapered portion, the tapered portion substantially freely receiving the mounting plate at an open end of the C-channel, and the tapered portion engaging the mounting plate at a restricted portion offset from the open end for restricting movement of the mounting plate relative to the tapered portion.

20. A mounting assembly as in claim 18, wherein:
a) A hump is provided on the C-channel, the hump being disposed inwardly of an open end of the C-channel, and the hump engaging the mounting plate and restricting movement of the mounting plate when the mounting plate is attached to the channel.

21. A mounting assembly as in claim 1, wherein:
a) the channel includes an e-channel.

22. A mounting assembly as in claim 1, wherein:
a) the channel includes a double-e-channel.

23. A mounting assembly as in claim 22, wherein:
a) the double-e-channel includes integral left and right e-channels, each having a substantially lowercase e-shaped configuration.

24. A mounting assembly, comprising:
a) a channel, the channel being mountable on an object to be moved;
b) a wheel assembly, the wheel assembly including:
i) a mounting plate, the mounting plate being detachably attachable to the channel;
ii) a wheel provided on the mounting plate, the wheel being movable relative to the mounting plate;
c) a lock being provided, the lock being configured for locking the mounting plate with the channel, the lock having a locked condition and an unlocked condition, the locked condition being a condition in which the mounting plate is substantially locked relative to the channel for preventing removal of the mounting plate from the channel, and the unlocked condition being a released condition in which the mounting plate is substantially free to move relative to the channel for being detached from the channel;
d) a signal being operatively associated with the lock, the signal being configuration for signaling the locked condition and the unlocked condition of the lock, the locked condition of the signal signaling the condition in which the lock is in its locked condition, and the unlocked condition of the signal signaling the condition in which the lock is in its unlocked condition;
e) the locked and unlocked conditions of the signal being visible; and
f) a V-shaped strengthening element being disposed adjacent the channel for strengthening the channel.

25. A mounting assembly as in claim 24, wherein:
a) the V-shaped strengthening element including a V-shaped plate extending over a majority of the length of the channel.

26. A mounting assembly as in claim 25, wherein:
a) the V-shaped strengthening element is disposed substantially only in a portion of the width of the channel.

27. A mounting assembly as in claim 24, wherein:
a) the channel is attached to the V-shaped strengthening element by a bending one of the channel and the V-shaped strengthening element.

28. A mounting assembly as in claim 24, wherein:
a) the channel is secured to the V-shaped strengthening element without welding.

29. A wheeled vehicle, comprising:
a) a rack;
b) a channel being mounted on the rack;
c) a wheel assembly, the wheel assembly including:
i) a mounting plate, the mounting plate being detachably attached to the channel;
ii) a wheel provided on the mounting plate, the wheel being movable relative to the mounting plate;
d) a lock being provided on the rack, the lock being configured for locking the mounting plate with the channel, the lock having a locked condition and an unlocked condition, the locked condition being a condition in which the mounting plate is substantially locked relative to the channel for preventing removal of the mounting plate from the channel, and the unlocked condition being a released condition in which the mounting plate is substantially free to move relative to the channel for being detached from the channel;
e) a signal being operatively associated with the lock, the signal being configuration for signaling the locked condition and the unlocked condition of the lock, the locked condition of the signal signaling the condition in which the lock is in its locked condition, and the unlocked condition of the signal signaling the condition in which the lock is in its unlocked condition; and
f) the locked and unlocked conditions of the signal being visible.

30. A vehicle as in claim 29, wherein:
a) the signal is a mechanical signal; and
b) the mechanical signal extends outwardly of the channel.

31. A vehicle as in claim 29, wherein:
a) the lock includes a hand-actuatable handle which extends outwardly of the channel.

32. A vehicle as in claim 29, wherein:
a) the lock includes a single fastener.

33. A mounting assembly as in claim 1, wherein:
a) the lock includes a single fastener.

34. A mounting assembly as in claim 8, wherein:
a) the mechanical block is gravity-actuated and in a normally blocking position

35. A vehicle as in claim 29, wherein:
a) the channel includes a first open end; and
b) a mechanical block is provided, the mechanical block being configured for preventing detachment of the mounting plate from the first open end when the mechanical block is in its normally blocking condition.

36. A vehicle as in claim 35, wherein:
a) the mechanical block is gravity-actuated into its normally blocking condition.

37. A vehicle as in claim 35, wherein:
a) the channel includes a second open end; and
b) a further mechanical block is provided, the further mechanical block being configured for preventing detachment of the mounting plate from the second open end when the further mechanical block is in its normally blocking condition.

38. A vehicle as in claim 35, wherein:
a) the mechanical block is provided in a vertically extending portion of the rack.

39. A vehicle as in claim 29, wherein:
a) a securing element attaches the lock to the mechanical block, and at least one of the securing element and the mechanical block is configured for preventing the lock from being removed from the rack.
